(19) United States
(12) Patent Application Publication
(10) Pub. No.: US 2026/0108950 A1
(43) Pub. Date: Apr. 23, 2026

(54) ROTARY TOOL AND CLAMPING HOLDER AND CUTTING INSERT FOR THIS PURPOSE

(71) Applicant: Kennametal Inc., Latrobe, PA (US)

(72) Inventor: Anwar Sadat Mohideen Abdul, Fürth (DE)

(21) Appl. No.: 19/363,504

(22) Filed: Oct. 20, 2025

(30) Foreign Application Priority Data
Oct. 21, 2024 (DE) 1020242101575

(51) Int. Cl. B23B 27/10

(52) U.S. Cl. CPC B23B 27/10; B23B 2205/10; B23B 2205/12

(57) ABSTRACT

A rotary tool is specified, comprising a cutting insert and a clamping holder extending in an axial direction wherein the clamping holder has a lateral surface extending in the axial direction, wherein the cutting insert has at least one cutting portion for machining a workpiece, and a fastening portion which is connected to the cutting portion, wherein the fastening portion has a fastening surface with which the cutting insert is detachably fastened to the lateral surface by means of a fastener, wherein the clamping holder has a support projection and a support, which each extend away from the lateral surface, wherein the fastening portion has a fastening portion upper side and a fastening portion lower side each of which is designed in a stepped manner in the axial direction, wherein an upper side partial surface of the fastening portion upper side abuts against a support projection surface of the support projection and a lower side partial surface of the fastening portion lower side abuts against the support. A cutting insert and a clamping holder are also specified.

### BACKGROUND OF THE INVENTION

Rotary tools are used in machining technology to process a workpiece using a lathe. The workpieces are usually made of wood, plastic, or metal. The workpiece is clamped into the lathe and set in rotation. The rotary tool is then guided along a feed direction against the rotating workpiece to shape it. Lathes with a Swiss machining process, in which the workpiece not only rotates during the machining process but can also be displaced along its axis of rotation, are particularly suitable for small parts machining with the highest precision.

Lathes can be equipped with various rotary tools depending on the requirements of the workpiece's shape. These include, for example, drills, chisels, and thread cutters. A lathe is often equipped with several rotary tools at the same time in order to perform different machining steps automatically, either sequentially or simultaneously, without the need for manual intervention to change tools.

Rotary tools can be made from a single piece of material, such as lathe tools. However, they can also consist of several parts, such as a clamping holder and a cutting insert attached to the clamping holder. The cutting insert is attached to one end of the clamping holder and inserted into a holder on the lathe at the other end.

The cutting insert is, for example, an indexable insert and has several cutting edges that can be positioned by turning the indexable insert on the clamping holder after a previous cutting edge has broken off or become blunt.

The precise design and connection of the cutting insert and clamping holder is the subject of current research and development. The aim is to develop rotary tools that are particularly easy to handle, space-saving, mechanically stable, and cost-effective.

### OBJECT OF THE INVENTION

The invention has the task of specifying a particularly suitable rotary tool, as well as a clamping holder and a cutting insert for such a rotary tool.

### ACHIEVEMENT OF THE OBJECT

According to the invention, the task with respect to the rotary tool is solved by the features according to claim 1, with respect to the cutting insert by the features according to claim 15, and with respect to the clamping holder by the features according to claim 16. Advantageous embodiments and further developments are the subject of the dependent claims (subclaims).

The following description describes the invention with regard to a design form of the cutting insert as a reversible cutting insert with two cutting portions. Similarly, the features described and their technical advantages are also transferable to cutting inserts with only one or more than two cutting portions. For reasons of clarity, these are not further explained or listed below, but are always included.

The rotary tool according to the invention has a cutting insert and a clamping holder extending in an axial direction, which has a lateral surface extending in the axial direction. The clamping holder also extends in an X-direction and in a Y-direction. The X-direction, the Y-direction, and the axial direction are mutually perpendicular. In particular, the clamping holder is square at its end facing away from the cutting insert so that it can be clamped into standard mounting recesses on lathes. A cross-sectional edge length (measured in the X-direction or in the Y-direction) of eight or ten millimeters is particularly preferred in order to be suitable for lathes for small parts machining.

The cutting insert has at least one cutting portion and one fastening portion. The cutting portion is characterized by at least one cutting edge which is suitable for removing material from a workpiece. Preferably, the cutting edge is made of a hard metal, in particular with a carbide insert, in order to be suitable for the machining of metals. The fastening portion has a fastening surface with which the cutting insert is detachably fastened to the lateral surface using a fastener. The cutting insert is generally mounted on the clamping holder such that the cutting insert also extends in the axial direction.

The cutting portion is connected to the fastening portion in particular in a material-locking manner, i.e., in one piece, monolithically. Suitably, both sections are made of the same material so that they merge smoothly into one another and a boundary between them is formed only by a surface contour, if necessary. In particular, such a contour extends perpendicular to the axial direction when viewed from the lateral surface. If the cutting insert has several cutting portions, these are preferably of the same type and each connected to the fastening portion as described. In the case of several cutting portions, the fastening portion also acts as a central link between the cutting portions.

With the fastening surface, the cutting insert is detachably fastened to the lateral surface of the clamping holder by means of a fastener. In other words, the cutting insert is attached to the clamping holder with the fastener so that the fastening surface abuts the lateral surface.

In particular, the cutting portion of the front side of the clamping holder protrudes at least partially in order to enable the cutting portion to be sunk into the surface of the workpiece during machining. The front side of the clamping holder defines, in the axial direction, the end of the clamping holder that faces the cutting insert and thus in particular also a workpiece during its machining.

The fastener is preferably a screw, in particular a clamping screw. Preferably, fastening is therefore carried out by means of one or more, in particular two, clamping screws as fasteners. In particular, the clamping screws each have a screw head at one end for accommodating a fastening tool. Attachment is carried out in a fastening direction, Y-direction, whereby the fastening surface of the cutting insert is connected to the lateral surface of the clamping holder in a force-fit manner. The fastener thus presses the fastening surface and the lateral surface together. It is particularly preferred that both surfaces lie flat against each other. For this purpose, the cutting insert has a corresponding feedthrough adapted to each screw and the clamping holder has a corresponding threaded hole. It is particularly preferred that the feedthroughs on the side facing the screw head of the respective screw are countersunk and/or threaded in order to fix the clamping screws. In particular, each threaded hole is offset in the axial direction relative to its corresponding feedthrough in such a way that the respective fasteners provides axial preload of the cutting insert (at least predominantly) on the clamping holder. The support projection and the support form an opening contour into which the cutting insert is drawn due to the preload. The support projection and/or the support form a counter bearing against which the cutting insert is pressed due to the preload.

Here and in the following, a “traction” or “non-positive connection” between at least two connected parts is understood in particular to mean that the connected parts are prevented from sliding against each other due to a frictional force acting between them. If there is no “connecting force” causing this frictional force (this means the force that presses the parts against each other, for example, a screw force or the weight force itself), the non-positive connection cannot be maintained and can therefore be loosened.

The conjunction and/or expresses here and in the following a combination of two features which are formed together or as alternatives to each other.

An important aspect of the invention is now, in particular, a special contouring of the clamping holder and the cutting insert, so that the cutting insert is held particularly advantageously in the clamping holder. For this purpose, the clamping holder has a support and a support projection, each of which extends away from the lateral surface. In particular, the support and the support projection are arranged on, in, or next to the lateral surface. Preferably, the support and the support projection are formed perpendicular to the lateral surface.

During machining of a workpiece, the support serves in particular as an abutment for the cutting insert when it is moved relative to the workpiece in the Y-direction, i.e., with the Y-direction as the feed direction. The workpiece is rotated around an axis of rotation during machining, which extends primarily in the Y-direction.

A surface of the clamping holder that is adjacent to the lateral surface and the support projection is defined here and in the following as the top side of the clamping holder. A surface of the clamping holder that is opposite the top side of the clamping holder is defined here and in the following as the bottom side of the clamping holder. The top side and bottom side of the clamping holder are spaced apart from each other in the X-direction by a distance which is also referred to as the height and which corresponds in particular to the aforementioned cross-sectional edge length. A surface of the clamping holder that adjoins both the lateral surface and the top side and bottom side of the clamping holder is defined here and in the following as the front side of the clamping holder. The front side of the clamping holder is in particular perpendicular to the axial direction.

The fastening portion has a fastening portion upper side and a fastening portion lower side, each of which is designed in a stepped manner in the axial direction. In other words, viewed along the axial direction, the fastening portion has a step on both the fastening portion upper side and the fastening portion bottom. These two sides are defined here and in the following as the respective top view sides of the cutting insert. Preferably, the gradation of these two sides is in the axial direction (starting from the front side of the clamping holder) of the bottom side of the clamping holder in the X-direction. For example, the fastening portion upper side and bottom side first extends in the axial direction, then also in the X-direction at the step, i.e., diagonally overall, and finally again in the axial direction. The stepped shape prevents the cutting insert from twisting around an axis parallel to the axial direction and around an axis perpendicular to the top side of the clamping holder (i.e., in the X-direction) during fastening of the cutting insert to the clamping holder. This reduces the time required for fastening and prevents damage to the workpiece and the lathe due to incorrect positioning of the cutting insert.

In a particularly preferred embodiment, as already indicated at the outset, the cutting insert is designed as a reversible cutting plate with two cutting portions and can be attached to the clamping holder in exactly two different positions by rotating it (180°) around an axis parallel to the fastening direction.

An upper side partial surface of the fastening portion upper side abuts against a support projection surface of the support projection, and a lower side partial surface of the fastening portion lower side abuts against the support. This means that the fastening portion rests with its fastening portion upper side on the support projection and with its fastening portion lower side on the support, so that the cutting insert is enclosed by the support projection and the support. The upper side partial surface and lower side partial surface can each be formed as partial surfaces or as total surfaces of the fastening portion upper side and the fastening portion lower side. The cutting insert is thus fixed in a positive-locking manner between the support projection and the support surface, and its cutting portion can effectively dissipate any process forces that occur, in particular forces in a direction perpendicular to the top side of the clamping holder (i.e., in the X-direction), into and via the clamping holder. In particular, rotation of the cutting insert about an axis parallel to the fastening direction, Y-direction, is prevented. The fastening portion thus forms a contour of the cutting insert (first contour), which interacts advantageously with a correspondingly matching contour of the clamping holder (second contour) such that the cutting insert is held securely in the clamping holder. The contour of the clamping holder is largely determined by the support section and the support.

Here and in the following, a “positive form locking” or “positive-locking connection” between at least two connected parts is understood in particular to mean that the connected parts are held together in at least one direction by direct interlocking of the contours of the parts themselves or by indirect interlocking via an additional connecting part. The “blocking” of mutual movement in this direction is therefore due to the shape.

In a preferred further development, the cutting insert abuts at least three surfaces of the clamping holder, which extend away from the lateral surface, in a positive-locking manner. Preferably, the cutting insert should abut one surface of the support projection and two surfaces of the support. This increases the effect of the positive form locking, particularly with regard to forces acting on the cutting insert in the X-direction and/or axial direction. This means that the cutting insert is held in a fixed position on the clamping holder during the machining of a workpiece, thereby increasing the accuracy of the machining.

In particular, the support projection surface of the support projection is positioned in the axial direction between two fasteners with which the cutting insert is detachably fastened to the lateral surface, as described above. This arrangement further increases the positional stability of the cutting insert during machining and thus also the resulting machining accuracy.

Preferably, the two fasteners are offset relative to each other in height, i.e., in the X-direction. The resulting offset follows in particular the gradation of the fastening portion and allows for greater support under the fastener that faces the front side of the clamping holder in the axial direction. This local reinforcement of the support allows forces in the X-direction at the cutting portion, in particular those facing the fastening portion upper side, to be absorbed and compensated by the clamping holder. This prevents the cutting insert from breaking out of the clamping holder during the machining of a workpiece, or rather, the cutting insert can be driven against the workpiece with a higher force. This is particularly advantageous when machining workpieces made of hard materials. In addition, this reinforcement of the clamping holder's support, with a constant overall height of the rotary tool, enables a saving in cutting insert material and thus a reduction in the cost of the rotary tool, since the material of the cutting insert is typically more expensive and/or of higher quality than the material for the clamping holder.

In a preferred embodiment, the support projection surface forms an angle in the range of 10 to 80 degrees with respect to the support. In other words, the support projection surface and the support are arranged at the aforementioned angle to each other. When the lateral surface is viewed from above, this V-shaped arrangement of the support projection surface and the support surface is advantageous because it allows the cutting insert to snap into place on the clamping holder and, in particular, prevents it from penetrating further into the clamping holder in the axial direction from the front side of the clamping holder due to the V-shaped positive-locking connection. This facilitates the insertion of the cutting insert into the clamping holder when loading the lathe. In addition, forces acting on the cutting insert in the axial direction against the clamping holder are dissipated into the clamping holder during the machining of a workpiece and compensated by the clamping holder. This allows the cutting insert to be driven against the workpiece with a higher force in the axial direction. This is particularly advantageous when machining workpieces made of hard materials.

In an advantageous further development, the support has a front portion and a rear portion running in the axial direction, which are designed in a stepped manner complementary to the fastening portion lower side. Here, the gradation extends in the axial direction, starting from the front side of the clamping holder and also running in the X-direction towards the bottom side of the clamping holder. This adapts the contour of the clamping holder to the contour of the cutting insert and optimizes the positive form locking between the two parts. In addition, the interaction of the two contours results in the above-mentioned advantages of twist protection for the cutting insert during fastening to the clamping holder and local reinforcement of the support facing the front side of the clamping holder, or the front portion. In particular, the front portion is higher and/or thicker than the rear portion when measured in the X-direction, so that a pull-out protection for the cutting insert in the axial direction is also advantageously realized.

In particular, the lower side partial surface of the fastening portion lower side protrudes upward in a planar manner, and a rear portion partial surface of the rear portion protrudes upwardly in a planar manner relative to the rear portion so that they abut against each other. This creates a defined contact surface between the cutting insert and the clamping holder, which helps to protect the cutting portion and/or the cutting edge of the cutting insert from direct contact with the clamping holder and thus prevents the cutting portion and/or the cutting edge from becoming blunt due to the fastening position of the cutting insert on the clamping holder.

In a preferred embodiment, the rear portion has a cylindrical pin which protrudes from the lateral surface, in particular perpendicularly. The lower side partial surface rests against the pin to enable a positive form locking between the cutting insert and the clamping holder. This embodiment is particularly advantageous for clamping holders with small cross-sectional edge lengths, in particular of eight millimeters.

Regardless of how the front portion and rear portion of the support are specifically designed, they each form a support point (lower support points) for the fastening portion of the cutting insert at the bottom, i.e., on the underside of the fastening portion. At the same time, the support section advantageously forms a further support point (upper support point) for the cutting insert at the top, i.e. on the upper side of the fastening section, so that an advantageous three-point bearing is achieved overall. Viewed along the axial direction, the upper support point is preferably located between the two lower support points. The two lower support points are also arranged offset from each other in the X-direction, as described, in accordance with the stepped shape of the support.

Preferably, the fastening surface protrudes upwardly at least partially recessed inwardly from the fastening portion. In particular, the fastening surface is thus raised in an island-like manner relative to the fastening portion. This tapered shape guides the cutting insert through the respective contours of the cutting insert and the clamping holder during fastening, preventing direct contact between the cutting edge and/or the cutting portion and the clamping holder when fastened. This facilitates the fastening process and protects the cutting portion, especially its cutting edge, from blunting or damage caused by the fastening position of the cutting insert on the clamping holder.

In particular, the fastening surface is designed parallel to an opposing outer surface of the fastening portion in order to enable maximum and homogeneous force transmission of the fastener for the traction between the cutting insert and the clamping holder.

In a preferred further development, the support projection extends less far from the lateral surface than the support. This allows the cutting insert to first be placed on the support and then brought into contact with the support projection and the support projection surface. This guidance facilitates the fastening of the cutting insert to the clamping holder. In addition, the support projection protruding less far reduces the clamping holder material and thus the costs for the rotary tool.

In a preferred embodiment, the support projection surface, and thus the support projection, and the upper side partial surface, which are adjacent to each other, are tapered in the axial direction. This allows for an increased residual thickness of the fastening portion in the Y-direction, and thus additional stability of the cutting insert. This is particularly advantageous for cutting inserts with long cutting portions for large machining depths and for machining workpieces made of hard materials.

In another embodiment, the rotary tool comprises only one fastener. This saves fastener and thus costs for the rotary tool and is particularly suitable for rotary tools with short cutting portions for small machining depths of workpieces. In this case, the fastener is guided approximately centrally through the fastening portion, i.e., centrally, up to and including any possible deviation therefrom, in order to achieve the preload already described. However, even with preload, the feedthrough for the fastener is advantageously designed to be centered and central in the fastening portion. Since the associated threaded hole for the preload is then offset from the feedthrough, the fastener is not necessarily centered and central in the fastening portion.

In a preferred further development, the clamping holder has a channel for a coolant and/or lubricant to cool the cutting insert and/or the workpiece during machining of the workpiece. The channel extends inside the clamping holder and the clamping holder has an outlet head for the channel with at least one outlet opening into which the channel opens. The outlet head is connected to the clamping holder in a single monolithic piece and is preferably made of the same material. This allows coolant and/or lubricant to flow through the clamping holder to the cutting insert with its cutting portion and cutting edge, and to efficiently dissipate the process heat generated during machining of the workpiece. The outlet head engages at least partially in the step of the fastening portion upper side, thereby enabling a reduced maximum height, in the X-direction, of the rotary tool. This is particularly preferred for space-sensitive applications of rotary tools in lathes, and is therefore particularly advantageous for a rotary tool for lathes for small parts machining.

The rotary tool according to the invention is particularly suitable for small parts machining. The rotary tool according to the invention also enables a particularly large cutting depth.

The invention comprises a clamping holder and a cutting insert according to the preceding features and advantages.

### DESCRIPTION OF THE DRAWINGS

The invention is explained in more detail below with the aid of a drawing. These show, in simplified illustrations:

FIG. 1 a perspective view of a rotary tool with a cutting insert and a clamping holder,

FIG. 2 a top view of the rotary tool from FIG. 1,

FIG. 3 a top view of the cutting insert from FIG. 1,

FIG. 4 a bottom view of the cutting insert from FIG. 1,

FIG. 5 a perspective view of the cutting insert from FIG. 1,

FIG. 6 a further perspective view of the cutting insert from FIG. 1,

FIG. 7 a perspective view of a section of the clamping holder from FIG. 1,

FIG. 8 a side view of a section of the rotary tool from FIG. 1,

FIG. 9 a perspective view of an alternative rotary tool with a cutting insert and a clamping holder,

FIG. 10 a perspective view of a section of the clamping holder from FIG. 9,

FIG. 11 a perspective view of the cutting insert from FIG. 9,

FIG. 12 a top view of the cutting insert from FIG. 9,

FIG. 13 a bottom view of the cutting insert from FIG. 9,

FIG. 14 a side view of the cutting insert from FIG. 9,

FIG. 15 a further side view of the cutting insert from FIG. 9,

FIG. 16 in a side view (and as an insertion in a view from below), a section of an alternative rotary tool with a cutting insert and a clamping holder,

FIG. 17 a perspective view of an alternative rotary tool with a cutting insert and a clamping holder,

FIG. 18 a perspective view of a section of the clamping holder from FIG. 17,

FIG. 19 a side view of the clamping holder from FIG. 17,

FIG. 20 a side view of a section of the rotary tool from FIG. 17,

FIG. 21 a side view of the cutting insert from FIG. 17,

FIG. 22 a further side view of the cutting insert from FIG. 17.

Corresponding parts and sizes are always marked with the same reference symbols in all figures.

### DESCRIPTION OF THE EXEMPLARY EMBODIMENTS

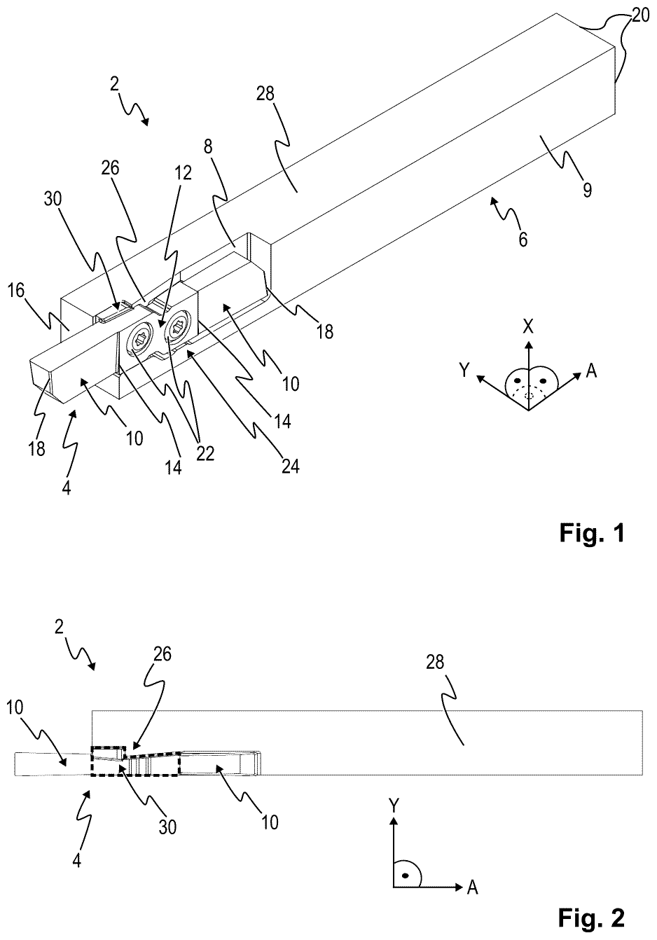

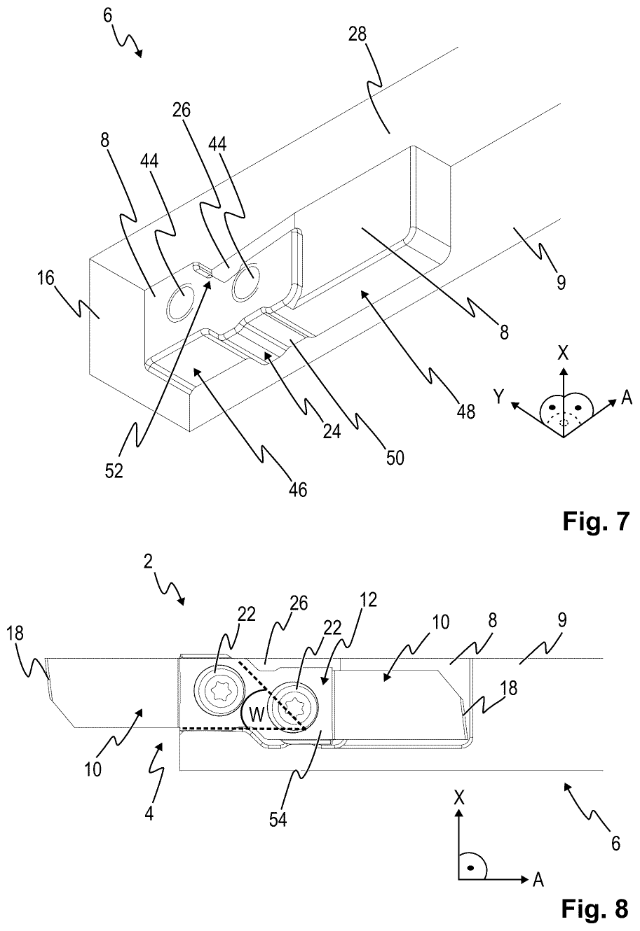

FIG. 1 shows a rotary tool 2 with a cutting insert 4 and a clamping holder 6 extending in an axial direction A. The clamping holder 6 has a lateral surface 8 extending in the axial direction A, which is particularly clearly visible in FIG. 7. The clamping holder 6 also extends in an X-direction X and in a Y-direction Y. The X-direction X, the Y-direction Y, and the axial direction A are mutually perpendicular in pairs. The cutting insert 4 has at least one cutting portion 10 for machining a workpiece and a fastening portion 12. The cutting portion 10 is connected to the fastening portion 12, in this case even in a material-locking manner, i.e., in one piece, monolithically. In particular, both portions are made of the same material, so that they merge smoothly into one another and a boundary between them is formed, if necessary, only by a surface contour 14. In particular, such a surface contour 14 extends in the X-direction X perpendicular to the axial direction A.

FIG. 1 shows an exemplary embodiment with a cutting insert 4 that has two cutting portions 10. The cutting insert 4 is designed here as a reversible cutting insert with two cutting portions 10, and one of its cutting portions 10 protrudes beyond a front side of the clamping holder 16 in the axial direction A. Each cutting portion 10 has at least one cutting edge 18 for machining the workpiece. For the sake of clarity, the workpiece is not explicitly shown here, but the cutting edge 18, which protrudes beyond the front side of the clamping holder 16 in the axial direction A, faces the workpiece during its machining and performs the machining operation on it. In particular, the protruding cutting portion 10 allows its cutting edge 18 to be sunk into a surface of the workpiece. The end of the clamping holder 6 opposite the front side of the clamping holder 16 is designed here, for example, as square with cross-sectional edges 20 each ten millimeters long so that it can be clamped in lathes for small parts machining.

The cutting insert 4 is generally detachably fastened to the lateral surface 8 of the clamping holder 6 by means of a fastener 22; FIG. 1 shows an exemplary embodiment with two fasteners 22. The cutting insert 4 is generally mounted on the clamping holder 6 such that the cutting insert 4 also extends in the axial direction A. The fasteners 22 are each designed as clamping screws and are screwed to the clamping holder 6 along the Y-direction Y through the fastening portion 12.

The clamping holder 6 has a support 24 and a support projection 26, each of which extends away from the lateral surface 8. In particular, the support 24 and the support projection 26 extend in the Y-direction Y perpendicular to the lateral surface 8. The support projection 26 adjoins a top side of the clamping holder 28 of the clamping holder 6.

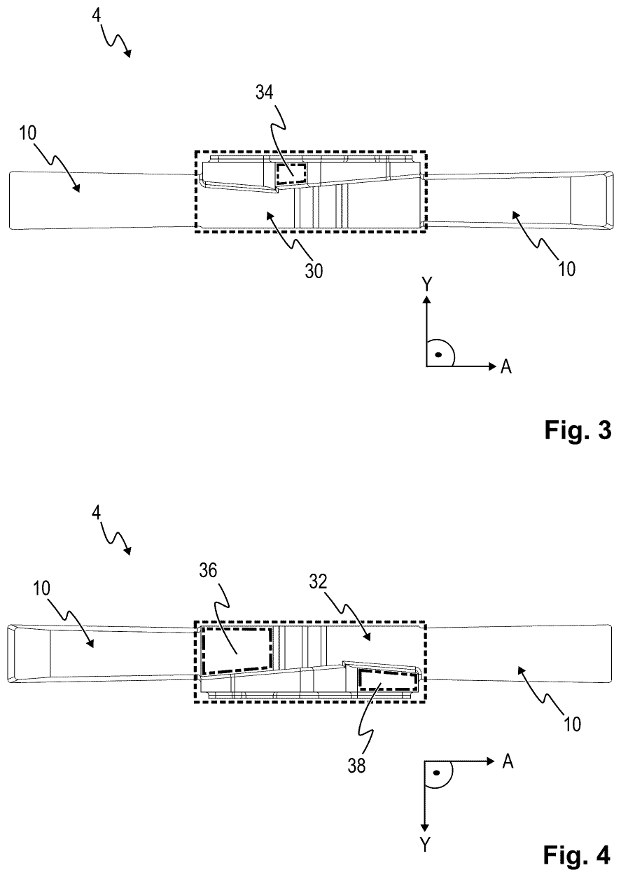

The fastening portion 12 has a fastening portion upper side 30 (see also FIG. 3) and a fastening portion lower side 32 (see also FIG. 4). These two sides are defined here as respective top view sides in the X-direction X of the cutting insert 4 In FIG. 1, only the fastening portion upper side 30, which partially abuts the support projection 26, is partially visible, while the opposing fastening portion lower side 32, which partially abuts the support 24, is obscured by the perspective view. Since the cutting insert 4 is designed here as a reversible cutting insert, the two sides 30, 32 are interchangeable. However, for the sake of clarity and generalizability with regard to the number of cutting portions 10, they are provided with different reference symbols here. The respective assignment is shown in FIG. 1 by the orientation of the cutting insert 4 in relation to the clamping holder 6. Here, the fastening portion upper side 30 rests at least partially on the support projection 26 and the fastening portion lower side 32 rests at least partially on the support 24. The cutting insert 4 is thus surrounded by the support projection 26 and the support 24.

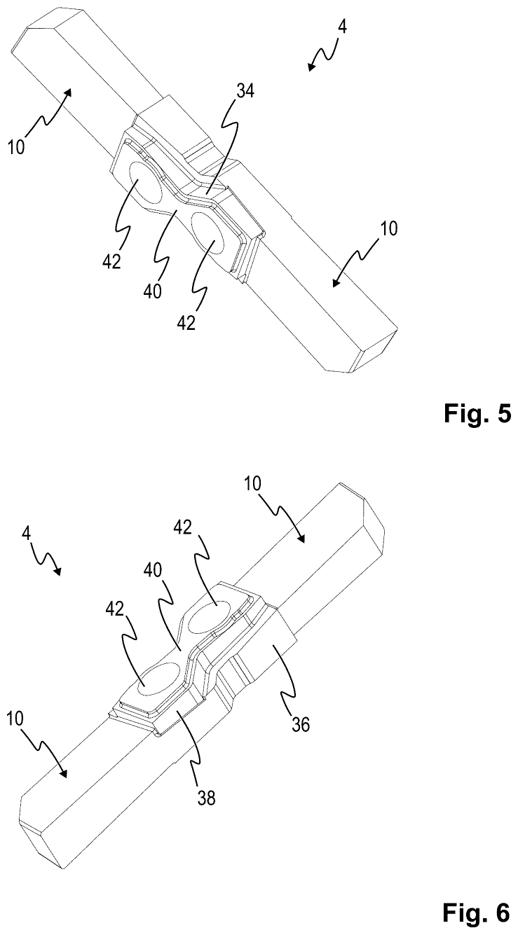

The fastening portion upper side 30 and the fastening portion lower side 32 are each designed in a stepped manner in the axial direction A, as can be seen particularly well in FIGS. 5 and 6, for example. In other words, viewed along the axial direction A, the fastening portion 12 has a step both on the fastening portion upper side 30 and on the fastening portion lower side 32. These two sides are graduated in the axial direction A (starting from the front side of the clamping holder 16) in the X-direction away from the top side of the clamp holder 28. Thus, the fastening portion upper side 30 and the fastening portion lower side 32 initially extend in the axial direction A, then also in the X-direction X at the step, i.e., diagonally overall, and finally again in the axial direction A.

FIG. 2 shows the rotary tool 2 from FIG. 1 from above in a top view, i.e., in the X-direction X with a clear view of the top side of the clamping holder 28. The fastening portion upper side 30, which is partially covered by the support projection 26, is highlighted with a dashed line.

FIG. 3 shows the cutting insert 4 from FIG. 1 from above in a top view, i.e., along the X-direction X with a clear view of the fastening portion upper side 30. The fastening portion upper side 30 is highlighted with a dashed line. The fastening portion upper side 30 has an upper side partial surface 34 with which the fastening portion upper side 30 in FIG. 1 abuts against the support projection 26. The upper side partial surface 34 is tapered in the axial direction A. The upper side partial surface 34 is highlighted here with a dotted line.

FIG. 4 shows the cutting insert 4 from FIG. 1 from below in a top view, i.e., along the X-direction X with a clear view of the fastening portion lower side 32. The similarity to the illustration in FIG. 3 is clearly recognizable, which results from the symmetry of the cutting insert 4. The fastening portion lower side 32 is highlighted with a dashed line. The fastening portion lower side 32 has a first lower side partial surface 36 and a second lower side partial surface 38, with which the fastening portion lower side 32 in FIG. 1 abuts against the support 24. The two surfaces 36, 38 are highlighted here by a dotted line. Thus, the cutting insert 4 in FIG. 1 with at least three surfaces, 34, 36, 38, abuts, in a positive-locking manner, on three surfaces of the clamping holder 6, which extend away from the lateral surface 8.

FIG. 5 shows the cutting insert 4 from FIG. 1 in a perspective view with a clear view of the fastening portion upper side 30, which is not explicitly shown again for the sake of clarity. The fastening portion 12 has a fastening surface 40, with which the cutting insert 4 is detachably fastened to the lateral surface 8 by means of a fastener 22 in FIG. 1. Attachment is carried out in a fastening direction, Y-direction Y, whereby the fastening surface 40 of the cutting insert 4 is connected to the lateral surface 8 of the clamping holder 6 in a force-fit manner. The fastener 22 thus presses the fastening surface 40 and the lateral surface 8 together. It is particularly preferred that both surfaces lie flat against each other. The fastening surface 40 protrudes upwardly at least partially recessed inwardly from the fastening portion 12. In particular, the fastening surface 40 is thus raised in an island-like manner relative to the fastening portion 12. The cutting insert 4 generally has one, in this case specifically two, feedthroughs 42 through the fastening portion 12 for the fastener 22. As can be seen in FIG. 5, the fastening surface 40 here has approximately the shape of the number “8”.

FIG. 6 shows the cutting insert 4 from FIG. 1 in another perspective view with a clear view of the fastening portion lower side 32, which is not shown explicitly again for the sake of clarity.

FIG. 7 shows a front section of the clamping holder 6 from FIG. 1 in a perspective view. The lateral surface 8 extends in the axial direction A and is set back in relation to another lateral surface 9 of the clamping holder 6 when viewed along the Y-direction. The lateral surface 8 is also parallel to the other lateral surface 9. In particular, the lateral surface 8 is divided into two different sub-surfaces, which differ in their position relative to the Y-direction. This division is optional and facilitates the fastening of the cutting insert 4 to the clamping holder 6. In particular, the lateral surface 8 in the exemplary embodiment shown in FIG. 10 does not have such a division along the Y-direction. The support projection 26 extends less far away from the lateral surface 8 than the support 24. The clamping holder 6 has a threaded hole 44 for receiving the fastener 22. In the exemplary embodiment shown, the clamping holder 6 has two threaded holes 44. The support 24 has a front portion 46 and a rear portion 48 extending in the axial direction A, which are designed to be offset from each other in a stepped manner complementary to the fastening portion lower side 32. Here, the gradation extends in the axial direction A, starting from the front side of the clamping holder 16, also in the X-direction X away from the top side of the clamping holder 28. Thus, the front portion 46 is higher and/or thicker than the rear portion 48 when measured in the X-direction X. A rear portion partial surface 50 of the rear portion 48 protrudes upwardly in a planar manner from the rear portion 48. The second lower side partial surface 38 also protrudes upwardly in a planar manner from the fastening portion lower side 32. Thus, in FIG. 1, the rear portion partial surface 50 abuts the second lower side partial surface 38. The first lower side partial surface 36 thus abuts the front portion 46 of the support 24 of the clamping holder 6 in FIG. 1. The support projection 26 has a support projection surface 52 against which the upper side partial surface 34 of the fastening portion upper side 30 abuts in FIG. 1. The support projection surface 52 forms an angle W with the front portion 46 of the support 24 in the range of 10 to 80 degrees. This angle W is marked with a dashed line in FIG. 8. The support projection surface 52 is tapered in the axial direction A.

FIG. 8 shows a section of the rotary tool 2 from FIG. 1 in a side view of the lateral surface 8, which is largely covered here by the cutting insert 4. The two fasteners 22 are offset from each other in height, i.e., in the X-direction. The resulting offset follows the gradation of the fastening portion 12. The support projection surface 52 (covered here by the cutting insert 4) is positioned in the axial direction A between the two fasteners 22. The fastening portion 12 also has an outer surface 54, which is clearly visible here and is formed parallel to the fastening surface 40.

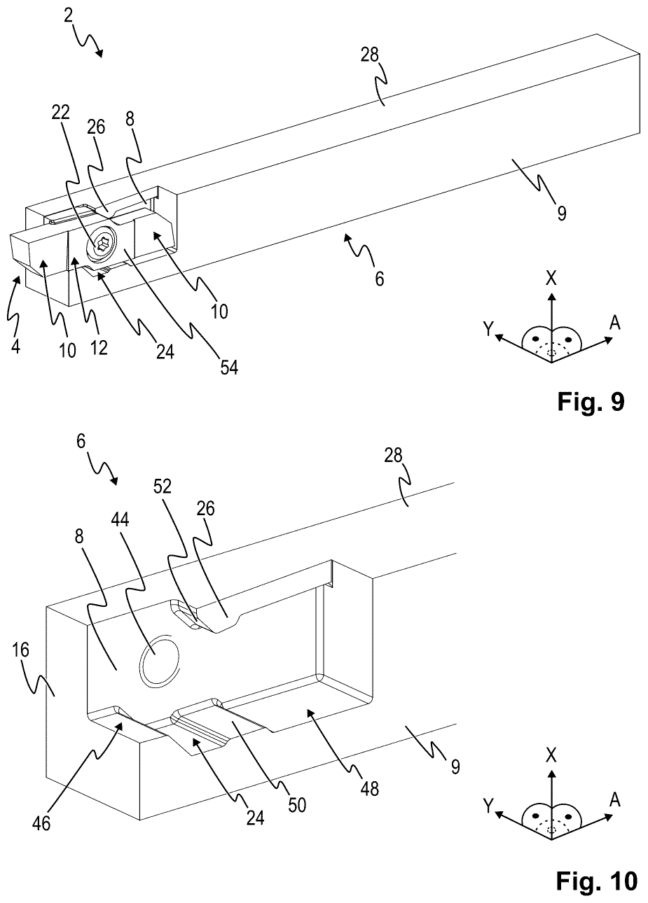

FIG. 9 shows an alternative embodiment of the rotary tool 2 with a cutting insert 4 and a clamping holder 6 in a perspective view. Here, the cutting insert 4 is attached to the clamping holder 6 with only a single fastener 22. The fastener 22 is passed through the fastening portion 12 approximately in the center.

FIG. 10 shows a section of the clamping holder 6 from FIG. 9 in a perspective view. The front portion 46 and the rear portion 48 with its rear portion partial surface 50 are clearly visible, analogous to FIG. 7; the above explanations apply accordingly.

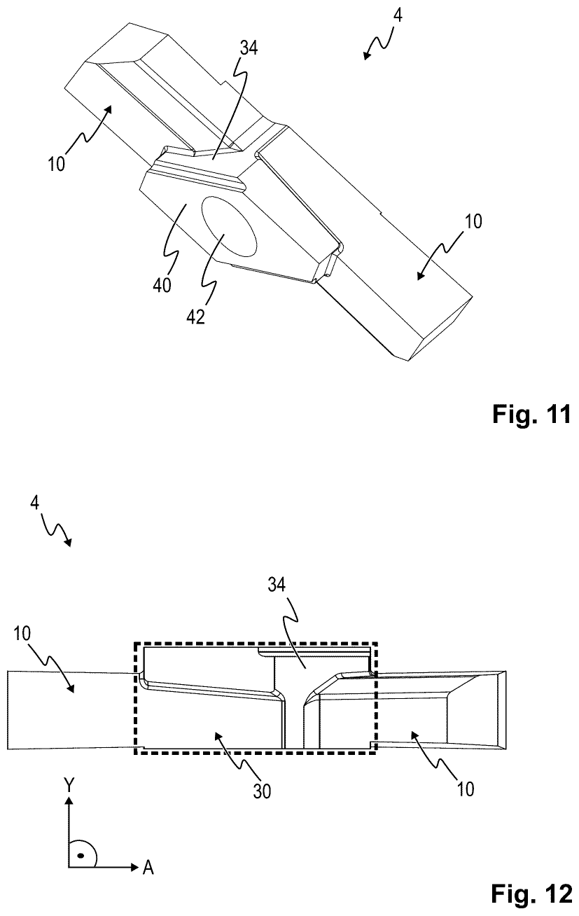

FIG. 11 shows the cutting insert 4 from FIG. 9 in a perspective view. The fastening surface 40 here has the shape of a rhombus or a trapezoid with truncated tips.

FIG. 12 shows the cutting insert 4 from FIG. 9 from above in a top view, i.e., along the X-direction X with a clear view of the fastening portion upper side 30. The fastening portion upper side 30 is highlighted with a dashed line.

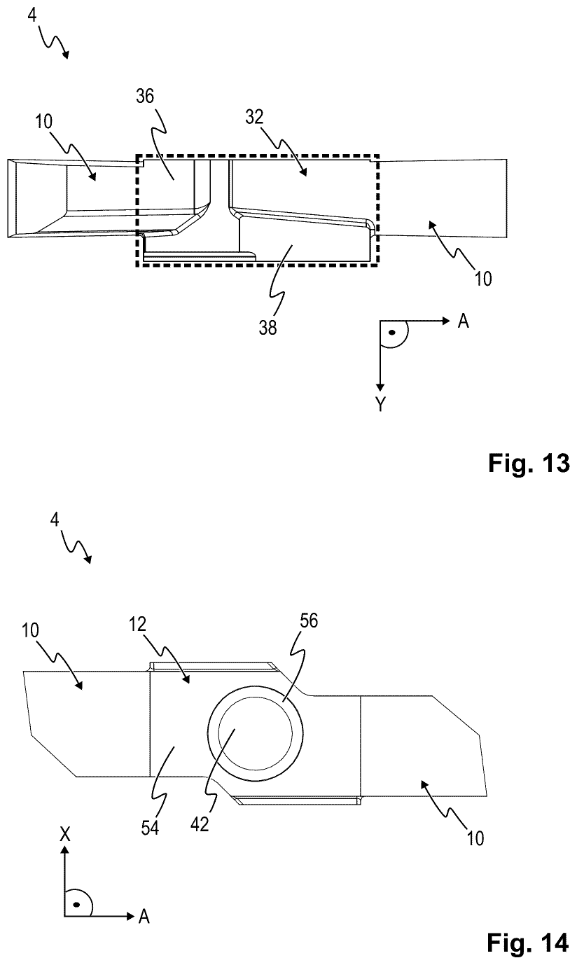

FIG. 13 shows the cutting insert 4 from FIG. 9 from below in a top view, i.e., along the X-direction X with a clear view of the fastening portion lower side 32. The fastening portion lower side 32 is highlighted with a dashed line. The first lower side partial surface 36 flows smoothly, without contouring, into the cutting portion 10, which in FIG. 9 protrudes in the axial direction A from the clamping holder 6 at its front side of the clamping holder 16.

FIG. 14 shows the cutting insert 4 from FIG. 9 in a side view of the outer surface 54 of the fastening portion 12. The feedthrough 42 has a truncated cone-shaped stop 56, which is recessed in the Y-direction Y relative to the outer surface 54. This stop 56 serves to guide and fix a fastener 22; in particular, the stop 56 serves to create a preload. For this purpose, the fastener 22 preferably has a truncated cone-shaped surface which at least partially abuts against the stop.

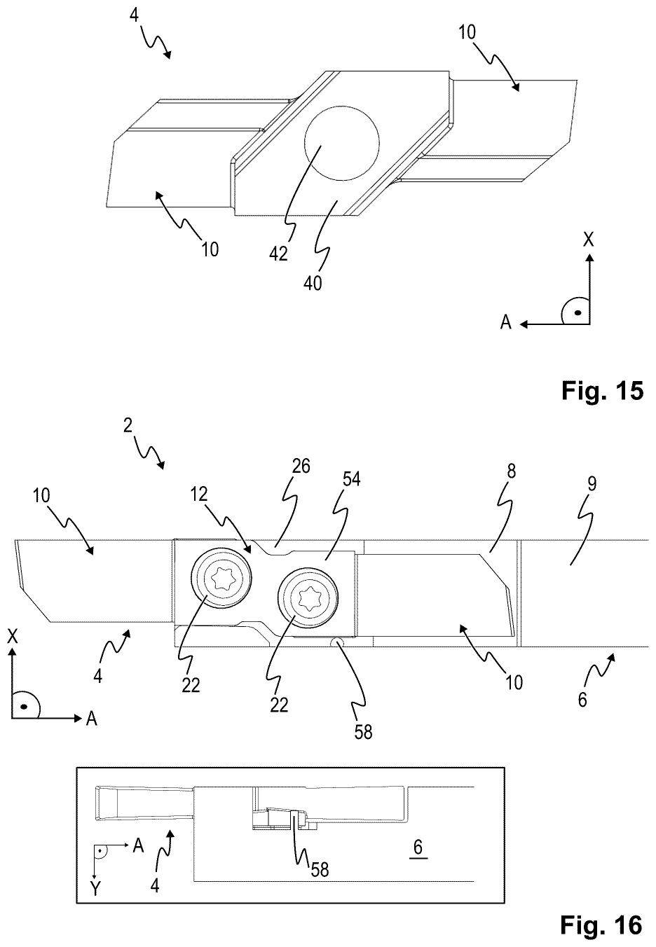

FIG. 15 shows cutting insert 4 from FIG. 9 in another side view of the fastening surface 40. FIG. 15 is therefore the rear view of FIG. 14, as the fastening surface 40 is designed parallel and opposing to the outer surface 54.

FIG. 16 shows a side view along the Y-direction Y with a clear view of the outer surface 54, showing a portion of an alternative embodiment for a rotary tool 2 with a cutting insert 4 and a clamping holder 6. The rear portion 48 here has a pin 58, which performs a function analogous to the rear portion partial surface 50 described above. In particular, the pin 58 is cylindrical in shape and protrudes perpendicularly from the lateral surface 8. The second lower side partial surface 38 of the cutting insert 4 abuts against pin 58 in a positive-locking manner. Pin 58 is ground flat here on one side facing away from cutting insert 4 so that it does not protrude beyond clamping holder 6 in the X-direction X. The second lower side partial surface 38 does not protrude upwardly from the fastening portion lower side 32, or only protrudes upwardly to a reduced extent, in order to further reduce the installation space in the X-direction X of the rotary tool 2. In particular, the rotary tool 2 in FIG. 16 has a total height, measured in the X-direction X, of eight millimeters. The rectangular frame shows the section of the rotary tool 2 from below.

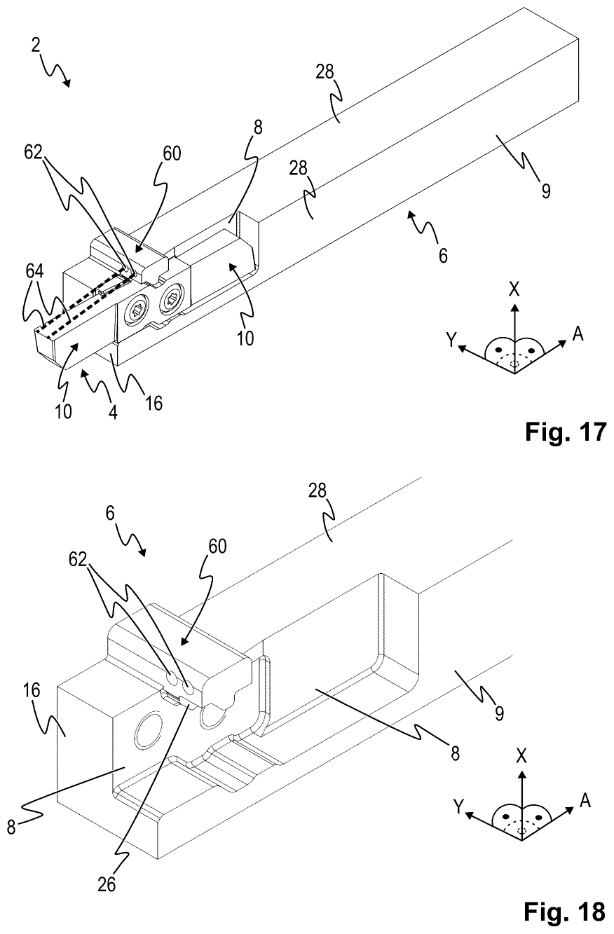

FIG. 17 shows an alternative embodiment of the rotary tool 2 with a cutting insert 4 and a clamping holder 6 in a perspective view. The illustration is initially similar to that in FIG. 1, but the clamping holder 6 in FIG. 17 additionally has an outlet head 60 with at least one outlet opening 62. In the exemplary embodiment shown, the outlet head 60 has exactly two outlet openings 62, from each of which coolant 64 flows in the direction of the cutting portion 10. This allows coolant 64 to be directed to the cutting portion 10 during the machining of a workpiece.

FIG. 18 shows a section of the clamping holder 6 from FIG. 17 in a perspective view. For clarity, the coolant 64 is not shown here.

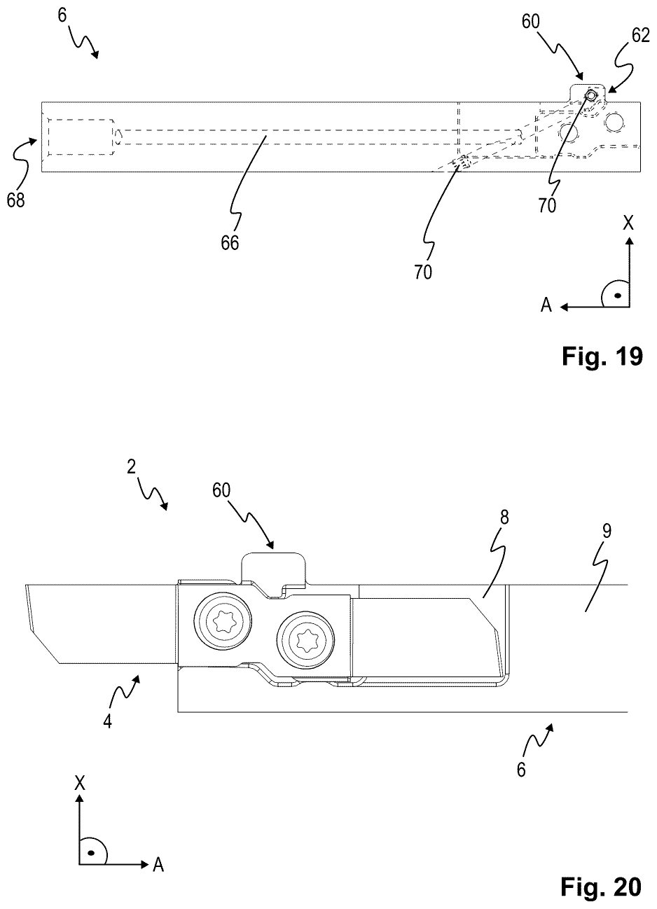

FIG. 19 shows the clamping holder from FIG. 17 in a side view on a surface opposite the lateral surface 8. The clamping holder 6 has a channel 66 for a coolant 64. The clamping holder 6 has an inlet opening 68 for the coolant 64. The channel 66 connects the inlet opening 68 to the outlet opening 62 in terms of fluid technology The clamping holder 6 has a plug 70 which closes the channel 66 such that coolant 64 entering through the inlet opening 68 can only leave the channel at the outlet opening 62. The exemplary embodiment shown has two plugs 70. The plugs 70 close the openings of the channel 66 which were created during the manufacture of the channel 66, in particular by drilling. Thus, the channel 66 extends inside the clamping holder 6 and opens into the outlet opening 62.

FIG. 20 shows a section of the rotary tool from FIG. 17 in a side view of the lateral surface 8. It can be clearly seen here how the outlet head 60 engages at least partially in the stepped fastening portion upper side 30 in the X-direction X. The coolant 64 is not shown here for the sake of clarity.

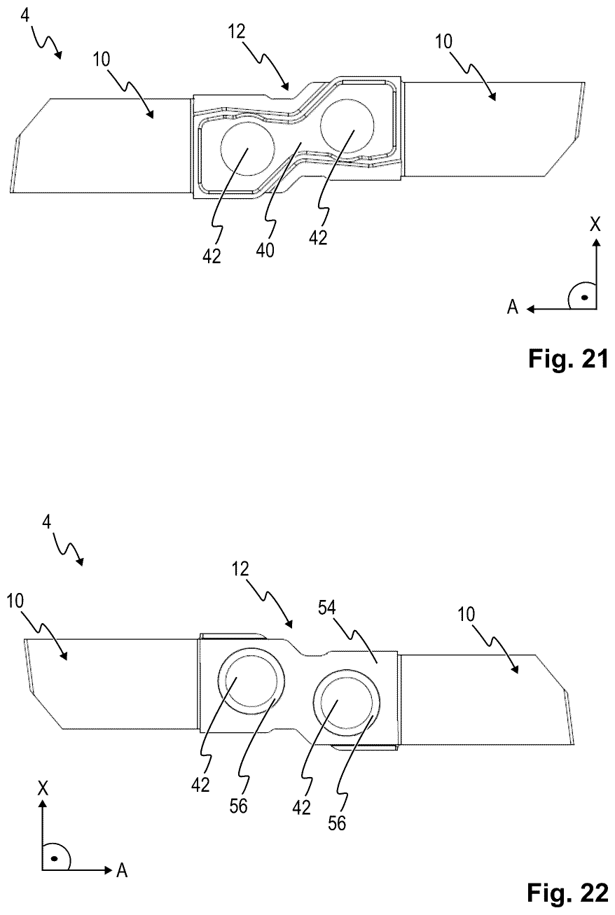

FIG. 21 shows the cutting insert 4 from FIG. 17 in a side view with a clear view of the fastening surface 40.

FIG. 22 shows the cutting insert from FIG. 17 in another side view with a clear view of the outer surface 54. FIG. 21 is thus the rear view to FIG. 22, since the fastening surface 40 is formed parallel and opposing to the outer surface 54.

In FIGS. 8, 16, and 20, an offset in the axial direction A of the fastener 22 relative to a corresponding stop 56 (visible in FIGS. 14 and 22) shows a preload of the cutting insert 4 in the axial direction A toward the clamping holder 6, i.e., away from the workpiece. In particular, a respective threaded hole 44 is arranged decentralized relative to its corresponding feedthrough 42. Such a decentralized embodiment is fundamentally independent of the number of fasteners 22 used and can therefore also be applied to embodiments with only one fastener 22.

1. A rotary tool, comprising a cutting insert and a clamping holder extending in an axial direction,
a. wherein the clamping holder has a lateral surface extending in the axial direction,
b. wherein the cutting insert has at least one cutting portion for machining a workpiece, and a fastening portion connected to the cutting portion (10),
c. wherein the fastening portion has a fastening surface with which the cutting insert is detachably fastened to the lateral surface by means of a fastener,
d. wherein the clamping holder has a support projection and a support, which each extend away from the lateral surface,
e. wherein the fastening portion has a fastening portion upper side and a fastening portion lower side, each of which is designed in a stepped manner in the axial direction,
f. wherein an upper side partial surface of the fastening portion upper side (30) abuts against a support projection surface of the support projection and a lower side partial surface of the fastening portion lower side abuts against the support,
g. wherein the support projection surface and the support surface are arranged in a V-shape.

2. The rotary tool according to claim 1, wherein the cutting insert abuts at least three surfaces of the clamping holder extending away from the lateral surface in a positive-locking manner.

3. The rotary tool according to claim 2, wherein the support projection surface is positioned in the axial direction between two fasteners, wherein the cutting insert can be releasably attached to the side surface, wherein the cutting insert has two passages through the fastening portion for the fasteners.

4. The rotary tool according to claim 3, wherein the fastening surface is raised to form an island relative to the fastening portion.

5. The rotary tool according to claim 4, wherein the support projection surface forms an angle in the range of 10 to 80 degrees with respect to the support.

6. The rotary tool according to claim 5, wherein the support has a front portion and a rear portion extending in the axial direction, which are designed to be offset relative to each other in a stepped manner complementary to the fastening portion lower side,
wherein the front portion and the rear portion each form a support point for the fastening portion of the cutting insert on the underside of the fastening portion and wherein the support projection forms a further support point for the cutting insert on the upper side of the fastening section so that three-point bearing is provided.

7. The rotary tool according to claim 6, wherein the lower side partial surface of the fastening portion lower side protrudes upwardly and a rear portion partial surface protrudes upwardly from the rear portion, wherein the lower side partial surface abuts against the rear portion partial surface.

8. The rotary tool according to claim 6, wherein the rear portion has a pin which protrudes from the lateral surface, wherein the lower side partial surface abuts the pin.

9. The rotary tool according to claim 8, wherein the fastening surface protrudes upwardly from the fastening portion at least partially recessed inwardly.

10. The rotary tool according to claim 9, wherein the fastening surface is formed parallel to an opposing outer surface of the fastening portion.

11. The rotary tool according to claim 10, wherein the support projection extends less far away from the lateral surface than the support.

12. The rotary tool according to claim 11, wherein the support projection surface and/or the upper side partial surface is tapered in the axial direction.

13. The rotary tool according to claim 12, wherein the fastening portion upper side and the fastening portion lower side diagonally across the step.

14. The rotary tool according to claim 13, wherein the clamping holder has a channel for a coolant for cooling the cutting insert,
wherein the channel extends inside the clamping holder,
wherein the clamping holder has an outlet head (60) for the channel, wherein the outlet head has at least one outlet opening,
wherein the channel opens into the outlet opening,
wherein the outlet head at least partially engages the stepped fastening portion upper side.

15. A cutting insert for a rotary tool according to claim 14, wherein the cutting insert is attached to the clamping holder of the turning tool in the axial direction and prevents the cutting insert from penetrating further into the clamping holder in the axial direction from the front side of the clamping holder due to the V-shaped positive-locking connection.

16. A clamping holder for a rotary tool according to claim 14.
